(19) United States
(12) Patent Application Publication
(10) Pub. No.: US 2006/0239804 A1
(43) Pub. Date: Oct. 26, 2006

(54) Vehicle for placing railcars on railway tracks

(76) Inventor: William Bernard Trescott, Bay City, TX (US)

Correspondence Address: William B. Trescott, 8208 HWY 457, Bay City, TX, 77414, US

(21) Appl. No.: 11/112,549

(22) Filed: Apr. 25, 2005

(51) Int. Cl. B60P 3/00

(52) U.S. Cl. 414/458

(57) ABSTRACT

A U-shaped vehicle with flexible beams equipped with an adjustable toe-angle, variable height suspension. Railway vehicles are attached between the beams of the vehicle. The rear suspension has a variable toe angle to control the spread of the beams so the vehicle can back around railway vehicles. Rear wheel axles are mounted on arms connected to pivot points. An axle and its pivot points are non-coplaner. The pivot points are angled so that an outer pivot point is higher than an inner pivot point. When the vehicle is lowered close to the ground, the rear wheels develop slight toe out. When the vehicle is raised above its normal ride height, the rear wheels develop slight toe in, and the beams of the vehicle spread apart when the vehicle is driven in reverse.

### FIELD OF THE INVENTION

The present invention relates to vehicles for transporting goods, and in particular to vehicles for transporting railway vehicles.

### BACKGROUND OF THE INVENTION

Vehicles and trucks of various kinds are widely available for transporting goods. Some transport goods on paved roads, while others are designed to operate on railway tracks. Cranes or other apparatus have usually been necessary for transferring vehicles from one form of transport to another.

It has long been known to provide a vehicle with both rubber tires for operation on highways as well as steel wheels for use when operating on railway tracks, such as shown by Wannamaker in U.S. Pat. No. 2,043,134 issued in 1936. Such a bi-modal vehicle is usually transported by road to a level crossing where a railway track intersects a highway. The vehicle is then turned diagonally across the track until the rail wheels are seen to be directly above the rails. The vehicle is then stopped and the steel wheels are lowered to engage the track. The vehicle's rubber tires can then be raised up while the vehicle is in transport by rail.

One skilled in the art will recognize that it is usually not possible for more than one rail axle to be positioned directly above the rails so as to simultaneously engage the track when a vehicle is moved across the rails diagonally. It is well known that railroad wheels have large flanges which must precisely engage the rails in order to prevent the wheels from falling off the track when the train negotiates a curve. Because of the difficulty of precisely positioning large heavy vehicles, bimodal vehicles are usually equipped with just one rail axle per vehicle. Single rail axles may work well with the smaller bimodal vehicles shown by Wannamaker, but on longer bimodal vehicles, a misalignment can occur when the vehicle travels around a curve in the track. The rail axle may cease to be perpendicular to the rails as the vehicle turns, causing a gap or looseness to occur between the track and the wheel flanges so that the axle no longer fits the rails precisely. This gap or looseness allows a phenomenon known as truck-hunt in which the rail vehicle sways and wiggles from side to side as it travels. Because both the track and wheel flanges are usually made of solid inflexible material such as steel, jarring vibrations can occur when the wheel flanges contact the sides of the rails, possibly damaging cargo and loosening the spikes that hold the track to the railroad ties or sleepers, which one knowledgeable in the art will recognize could result in a catastrophic derailment.

To avoid such dangers, those skilled in the art usually design bimodal vehicles with detachable rail wheels, such as shown in U.S. Pat. No. 6,050,197 to Wicks, which are mounted on multi-axle articulated rail-trucks or bogies similar to those of conventional railcars that will always be perpendicular to the track when the vehicles travel around curves. The rail-trucks or bogies are left behind on the track when such vehicles are being transported by road, thus avoiding the problem of precisely aligning rail wheels and track when transferring the vehicles back onto the rails. In U.S. Pat. No. 6,123,029, Mobley teaches that ordinary truck fifth-wheel turntables, such as are commonly used to couple highway truck-tractors with semi-trailers, can be fitted to the bogies to facilitate easy alignment.

Such a system may work well on a siding or in a rail yard, but abandoning large vehicle components on railway tracks creates a hazard to other trains that might collide with the detached rail-trucks or bogies if they are inadvertently left in the wrong place. This would be especially hazardous to magnetically levitated trains that travel at very high speeds because magnetic levitation tracks are usually not equipped with switches or sidings to allow such vehicles to travel around obstructions. Even when abandoned on a low speed spur line or siding, one skilled in the art will recognize that a vehicle component lacking standard couplers compatible with ordinary trains would obstruct other rail traffic because locomotives and other railway vehicles would have no capability of moving the obstruction out of the way.

It is an object of the present invention therefore, to provide a vehicle for easily and quickly positioning on railway tracks a long heavy railway vehicle having multiple articulated multi-axle rail-trucks or bogies and couplers like conventional railcars. It is a further object of the present invention to provide a vehicle for easily and quickly removing such railway vehicles completely from the tracks without abandoning any components that might pose a hazard or obstruction to other trains.

One form of vehicle for transporting goods has a U-frame with rearwardly extending side frames or beams. Such vehicles are shown, for example, in U.S. Pat. No. 4,556,365 to Niva and U.S. Pat. No. 5,879,122 to Voetzke. As explained by Niva, such trucks are driven backward to a container standing on the ground. The open end of the U-frame is moved backwards such that the U-frame will enclose the container on three sides. As mentioned in Niva and as described in Voetzke, a second inner U-frame is then lifted hydraulically to contact the container and lift it into a transport position. Niva seeks to eliminate the second inner lifting frame by providing a specialized coupling for connecting hydraulic cylinders on the vehicle directly to specialized brackets on the container. Nevertheless, it is still difficult to provide a vehicle that can be easily driven around a relatively long object such as a railcar. In both Niva and Voetzke, for example, the containers shown are relatively more narrow near the ground and have a widened top to engage an inner U-frame or special hydraulic lifts while providing clearance near the ground for the first U-frame of the vehicles. Such a shape for the container is suitable for the refuse containers described in Voetzke or the mining containers described by Niva. Rail vehicles, by contrast, need a rectangular shape so that they will not be top heavy when traveling at high speed around curves, for example. It is an object of the present invention, therefore, to provide a U-frame vehicle for moving rail cars and locomotives with improved facility for placing the vehicle around a substantially rectangular object.

In U.S. patent application Ser. Nos. 09/901,300 and 10/065,841, I described a U-shaped vehicle with facility for lifting intermodal shipping containers. This vehicle is also capable of lifting rail vehicles provided the rail vehicles are equipped with the same attachment mechanisms as intermodal containers. It is a further object of the present invention, therefore, to provide an improvement to my prior art by adding a specialized control means with increased facility for lifting rail vehicles and placing them on the tracks quickly and efficiently, regardless whether the rail vehicles have attachment mechanisms similar to intermodal shipping containers.

### SUMMARY OF THE INVENTION

The vehicle for placing railcars on railway tracks of my invention comprises a U-shaped frame with flexible side structures or beams which may be made of crash absorbent material and equipped with an adjustable toe-angle, variable height suspension. Railway vehicles are attached between the side structures or beams of the vehicle. The variable height front and rear suspension allows railway vehicles to be lifted off the tracks. The rear suspension also has a variable toe angle to control the spread of the flexible beams so it can back around a railway vehicle and then squeeze or grasp the vehicle so that it can be tightly secured while being lifted.

The vehicle for placing railcars on railway tracks has a wider than normal wheel base, low center of gravity, and crash absorbent side structures which will significantly improve highway safety. Heavy batteries for regenerative braking can be installed in the side structures to enhance crash absorbency. The variable height rear suspension of the vehicle may have a trailing beam design. Rear wheel axles can be mounted on one trailing beam or arm (like an aircraft landing gear), or two beams or arms (like the rear wheel of a mountain bicycle or motorcycle). Regardless of the number of arms, the angle of the pivot where the trailing arms are attached to the side structures of the vehicle is not level with the ground. The pivot bearing is angled so that the outer end is higher than the inner end so that when the vehicle is lowered close to the ground, the rear wheels develop slight toe-out and when the vehicle is raised above its normal ride height, the rear wheels develop slight toe-in. Thus, when the vehicle is lowered close to the ground, the side structures or beams spread apart when driven forward and toward each other when driven in reverse to allow the grasping and releasing of railway vehicles carried between the beams. When the vehicle is raised to a higher than normal ride height, the rear wheels develop toe-in and the side structures or beams of the vehicle spread apart when driven in reverse to steer around the front of a railway vehicle prior to lowering the vehicle to grasp it. They can also squeeze railway vehicles when driven forward to help secure them during an off road collision avoidance maneuver. A control means similar to the joystick of an airplane alters the height of the vehicle through a computer. By controlling ride height and direction, the driver can spread the side structures apart or pinch them together at will to grasp and release railway vehicles.

An improvement over my prior art is increased facility to precisely control the vehicle's lean or angle of tilt using a superior control means such as a joystick. This allows the wheels of railway vehicles to be placed on one track at a time—a feature not needed on vehicles used primarily for lifting intermodal shipping containers. Moving the joystick to the side leans the truck and at the same time changes the toe angle of the rear wheels so that as the truck leans, the rear wheels are made to steer in the same direction rather than developing toe-in or toe-out as happens when the height of the vehicle is changed. By steering with the rear wheels as well as the front, the vehicle can be made to move in a diagonal direction across the track while the vehicle itself is aligned with the track, thus allowing more than one rail axle to be engaged with a rail simultaneously.

One knowledgeable in the art will recognize that whenever wheels mounted on articulated bogies are misaligned, tilting a rail vehicle will cause the wheel lower to the ground to also be closer to the track, thus if the lower wheel of a bogie is correctly positioned on a rail, the other wheel(s) on the same side of the bogie can be brought into proper position on the same rail by lowering the entire vehicle while simultaneously moving it toward the rail, causing the bogie to swivel into proper alignment. All of the wheels on one side of a multi axle rail vehicle or group of rail vehicles can thus be placed on one rail at once, despite being mounted on articulated rail-trucks or bogies that may not initially be aligned with the tracks. A video camera is provided underneath the cab of the truck so that the operator can see if the wheels are correctly positioned and, if necessary, make necessary corrections by moving the joystick and the vehicle's steering wheel to obtain proper alignment. The vehicle is equipped with a further control means such as special joystick buttons to operate the front and rear suspensions independently or differentially to control the fore and aft pitch of the vehicle in much the same way as pitch is controlled in an aircraft. The vehicle's steering wheel, similar to that of ordinary trucks, can be turned to adjust the yaw of the vehicle with respect to the track, thus the vehicle can be precisely oriented on three axes independently of the direction of the vehicle's travel. Once all of the wheels on one side of a rail vehicle or group of rail vehicles are positioned on a rail, one skilled in the art will recognize that the wheels on the other side of the rail vehicle(s) will automatically be aligned with the other rail. The control means or joystick can then be moved to a neutral position to level the rail vehicle(s), thus causing all of the rail wheels to become mounted precisely on the track. This is an improvement over the prior art because the entire operation can be performed in less than a minute without auxiliary equipment such as springs or other mechanical means to bring the rail trucks or bogies into alignment.

### BRIEF DESCRIPTION OF THE FIGURES

FIG. 1 is a perspective view of a vehicle having two opposed beams according to the present invention with railway vehicles.

FIG. 2 is a perspective view of the vehicle of FIG. 1 without railway vehicles.

FIG. 3 is a perspective view of a rear wheel assembly according to the present invention.

FIG. 4 is a front plan view of the wheel assembly of FIG. 3.

FIG. 5 is a side plan view of a simplified left rear wheel assembly supporting a vehicle at a medium height above the ground.

FIG. 6 is a top plan view of the wheel assembly of FIG. 5.

FIG. 7 is a side plan view of the simplified left rear wheel assembly supporting a vehicle at an elevated height above the ground

FIG. 8 is a top plan view of the wheel assembly of FIG. 7.

FIG. 9 is a side plan view of the simplified left rear wheel assembly supporting a vehicle at a reduced height above the ground.

FIG. 10 is a top plan view of the wheel assembly of FIG. 9.

FIG. 11 is a plan view of a wheel assembly in extended position.

FIG. 12 is a simplified perspective view of the rear of the vehicle of FIG. 1 with a railway vehicle and a railway track.

FIG. 13 is a side plan view of a vehicle having two opposed beams according to the present invention with a railway vehicle.

FIG. 14 is a top plan view of the vehicle of FIG. 13 without a railway vehicle.

### DETAILED DESCRIPTION

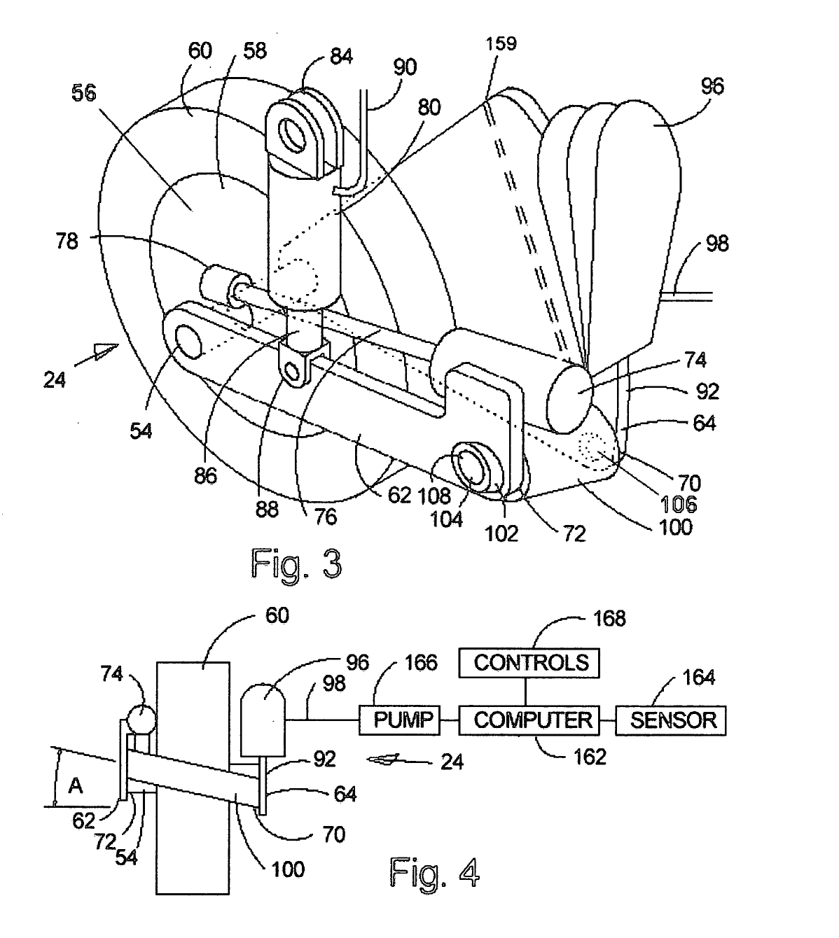

I will now describe the preferred embodiment of my invention with reference to the accompanying drawings, wherein like numerals are used to refer to like parts. FIG. 1 shows a perspective view of a vehicle 10 according to my invention. The vehicle 10 supports one or more railway vehicles 12 on two parallel bendable beams 14 & 16. The beams extend rearwardly from a cab 18. The cab comprises an operator's compartment where control apparatus for an operator are located (not shown) and has steerable wheels 22, controlled by the operator, and other standard features well known in the art. The vehicle may be powered by various means, such as by diesel or gasoline engines, by front or rear wheel drives, or by other well known means. In my preferred embodiment, a Diesel-electric or turbo-electric may be used. Rear wheel assemblies 24, 26, 28, 114, & 116 may be equipped with either direct electric drive, electric drive with planetary reduction, worm drive, or ring and pinion gear drive as shown in FIG. 3. Batteries 36 for regenerative braking may be installed, and the rear wheels may be equipped with emergency spring activated brakes (not shown) which will be applied automatically in the event of a computer failure and will only be released when the driver's foot is on an accelerator pedal. The vehicle 10 may be powered by a turbine generator (not shown) with compressed gas as fuel. Compressed gas tanks (not shown) should be located near the turbines so that any gas leaking out can be immediately burned in the turbine exhaust in a large chimney (not shown) installed in the roof of the cab 18. The compressed gas tanks may be housed inside a non-pressurized outer tank made of crash absorbent material equipped with a diaphragm separating the outer tank from the exhaust system so that leaking compressed fuel will burst the diaphragm and enter the exhaust chimney before the pressure capacity of the outer tank is exceeded.

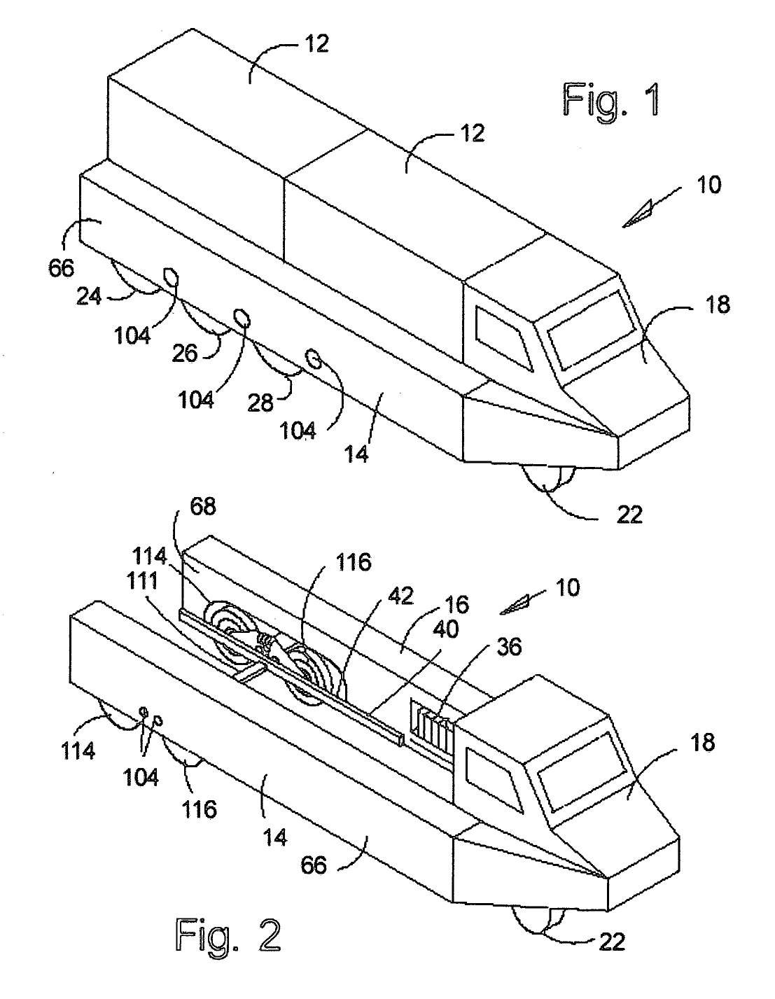

The beams 14 & 16 are bendable so that they can flex outwardly (away from each other) or inwardly (towards each other) in response to changing orientation of the rear wheels, as will be explained more fully below. Preferably, the beams 14 & 16 comprise generally rectangular fiberglass conduits with steel framing (not shown) supporting the rear wheels. In FIG. 2, the rear wheels 114 & 116 are shown through the beam 16 for viewing. Preferably, however, the beam would cover the wheels for strength.

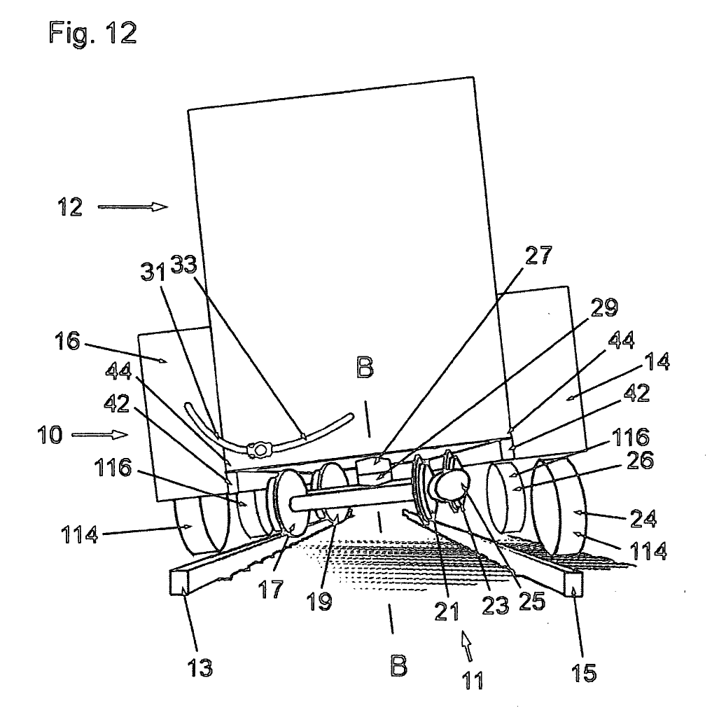

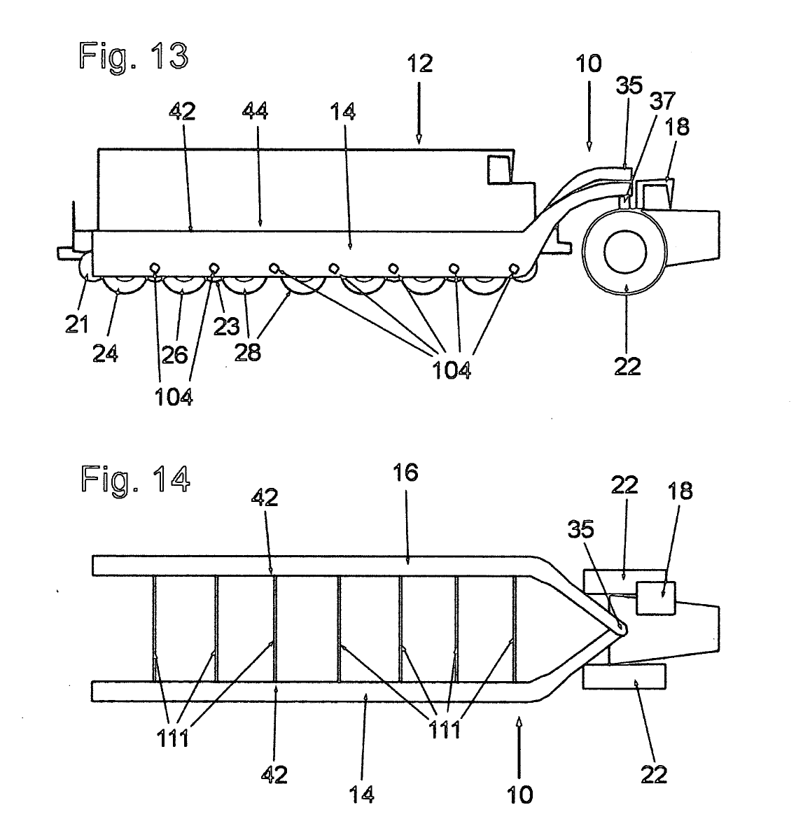

The wheel systems of vehicle 10 raise and lower the vehicle, as will be explained more fully below. As the vehicle is raised, at least some of the rear wheels change their orientation, such that as the vehicle moves backwards to engage a railway vehicle 12, the beams 14 & 16 are forced outwardly away from each other. Bending of the flexible beams provides sufficient clearance for a skilled operator to position the vehicle around railway vehicles. Although it is preferred to provide bending by the characteristics of the beam, the beams might also be attached to a hinge 35, for example, at their connection to the cab 18 as shown in an alternate embodiment in FIGS. 13 and 14 so that a less expensive less flexible material such as steel can be used to reduce the cost of the vehicle's construction. It will be understood that in this alternate embodiment, intended primarily for off-highway use such as placing railway vehicles back on the tracks after a derailment accident, the hinge 35 further comprises a hydraulic cylinder 37 capable of adjusting the height of the beams 14 & 16 with respect to the cab 18 to eliminate the need for a resilient front suspension system which is not needed on an off-highway vehicle. In this alternate embodiment, the front wheels 22 are inflexibly attached to the cab 18 to save cost, the steering of the vehicle being accomplished by pivoting the entire cab 18 by means of the hinge 35 using differential braking similar to that used on earth moving equipment to provide additional off-road maneuverability. Regardless of the type of beams, front suspension, and steering mechanism, before the vehicle 10 completely engages a railway vehicle 12, the beams 14 & 16 lower from above a normal drive height to a height near the track. As the vehicle changes height, the rear wheels change their orientation such that the beams are driven towards each other, allowing a lift ledge 42 on the beam to engage a lip 44 on a railway vehicle 12 as shown in FIG. 12. While the vehicle shown in FIG. 12 has lift ledges mounted near the bottom of the beams, one skilled in the art will recognize that such ledges could be mounted higher up or even on top of the beams to lift larger rail vehicles as shown in FIG. 13.

A right rear wheel assembly 24 according to my invention is shown in perspective view in FIG. 3. The wheel assembly 24 comprises an axle 54 supporting a wheel 56 comprising a hub 58 and a removable pneumatic tire 60. Certain conventional features such as brakes and mounting bolts are not shown. The axle is supported by an outer arm 62 and an inner arm 64. The outer arm 62 is usually adjacent an outer side 66 of a beam, away from the position of a railway vehicle 12. The inner arm 64 is usually adjacent an inner side 68 of a beam, near the position of a railway vehicle 12. The inner arm 64 is attached to the support frame 40 of a beam at a first pivot 70. The outer arm 62 is attached to the support frame 40 of the beam at a second pivot 72. In my preferred embodiment, an electric drive motor 74 is mounted on the outer arm 62. A drive shaft 76 couples the motor 74 to a gear 78 that turns the wheel 56. A hydraulic actuator 80 may be provided as a means for controlling the orientation and motion of the outer arm 62. The actuator 80 has cylinder 82 with a coupling 84 for connection to the beam and a piston 86 with a coupling 88 connected to the outer arm 62. A control line 90 conducts fluid to and from the cylinder 82 to control the extension of the actuator 80 in a known manner.

It will be apparent that in this configuration, the wheel 56 is removed from its axle towards the inside of the vehicle 10, as will be explained more fully below. The inner arm 64, therefore, is configured as a hinged, generally flat triangular suspension hanger 92 that can be removed to service the wheel. An air bellows 96 is attached to the suspension hanger 92. Together with the hydraulic actuator 80, the air bag controls the orientation of the wheel through the inner arm 64. An air line 98 provides air as a control fluid for expanding or contracting the bellows. Pneumatically controlled air bags are preferred because they provide a large range of expansion at relatively low cost, but other control means could also be used.

The first pivot 70 and the second pivot 72 may be connected by, for example, a sleeve 100. The arms may be rigidly connected to the sleeve and the pivots may be provided by the sleeve turning around an inner cylinder 102. A lubricant or other friction-reducing means would be provided between the inner cylinder and the sleeve. A cooling duct 104 extends through the inner cylinder. Preferably each cooling duct has an inlet 106 opening through the inner wall 68 of a beam and an outlet 108 extending through the outer wall 66 of a beam. Air flows through the cooling duct 104 to cool the lubricant between the inner cylinder 102 and the sleeve 100.

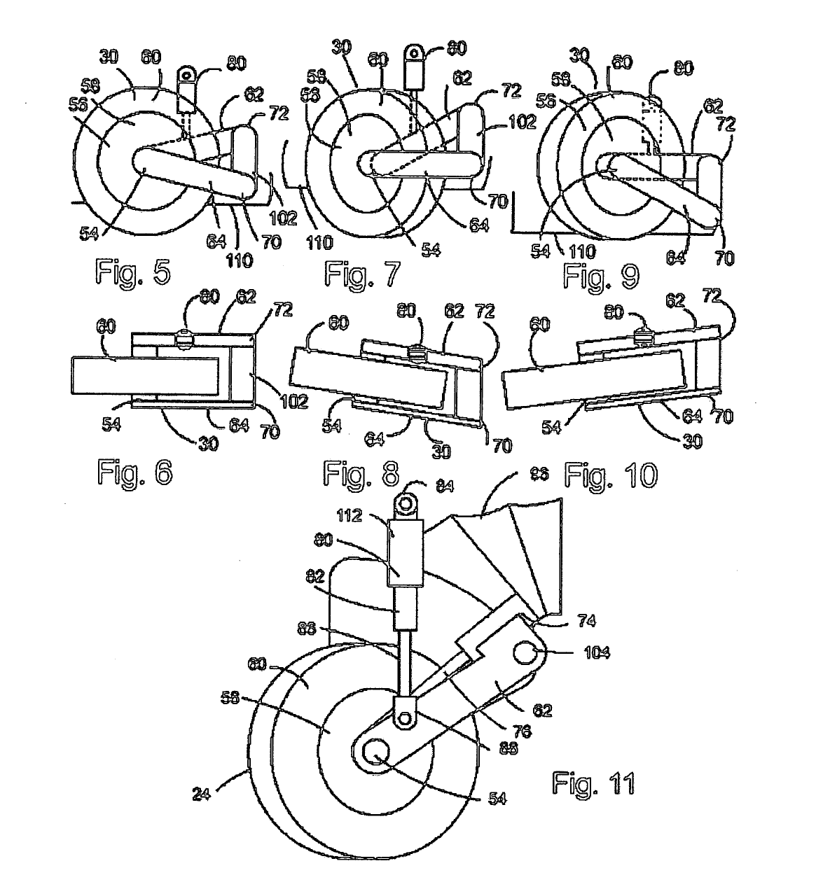

An important feature of the wheel assembly 24 can be seen in FIG. 4, a plan view of the right rear wheel assembly. The axle 54 is horizontal, while the sleeve 100 rises from the first pivot 70 to the second pivot 72. The second pivot is higher than the first pivot. Thus the axle and the two pivots (or the axle and the sleeve or inner cylinder) are non-coplanar, that is, if these elements were represented by a line and two points (or by two lines), they would not be contained in a single plane. A line between the first and second pivots is raised from the horizontal by an angle A. The angle A is preferably between 0.5 and 10 degrees, more preferably between 1 and 6 degrees and most preferably between 2 and 3 degrees. In particular, the angle A is preferably between 0.5 and 10 degrees for tri or quad-axle suspensions wherein the angle A may be greater on pivots located close to the rear of the vehicle and less on pivots located further away from the rear of the vehicle. As will be explained below, some of the wheel assemblies may have planar axles and pivot points. The angle A is preferably between 1 and 6 degrees particularly for tandem axle suspensions, with the angle A being greater on the pivots located close to the rear of the vehicle, and less on the pivots located farther from the rear of the vehicle. Some of the more forward wheel assemblies 28 & 116 may have planar axles and pivot points. For single axle suspensions, that is, one rear wheel assembly on each beam, the angle A is most preferably between 2 and 3 degrees. The effect of the non-planar axle and pivot points is represented in FIGS. 5 through 10. In these figures a left rear wheel assembly, a mirror image of the right rear wheel assembly shown in FIG. 3, is represented in a simplified fashion for clarity. The inner arm 64 is represented as a linear element, as is the outer arm 62 only the inner cylinder 102 is shown, and elements such as the sleeve, motor and bellows are omitted. It will be understood, however, that such elements may be used as described above. The inner cylinder 102 is considered to be towards the front of the vehicle 10 where the cab 18 is located.

FIG. 5 represents the wheel assembly 24 in a neutral position. The inner arm 64 slants upwardly from the first pivot 70 to the axle 54, while the outer arm 62 slants downwardly from the second pivot 72 to the axle. The vehicle 10 is at a drive height, as represented by a lower edge 110 of the beam 16. As shown in the top view of FIG. 6, this orients the axle parallel to the inner cylinder 102 and the wheel 56 is co-linear with the beam. When the arms 62 & 64 are forced down by the action of the actuator 80 and the air bellows 96 (not shown in these views), the vehicle 10 is elevated, as shown by the position of the lower edge 110 in FIG. 7. At the same time, the axle 54 is no longer perpendicular to the long axis of the beam, and the wheel 56 toes in toward the front of the vehicle, as shown in FIG. 8. If the vehicle 10 backs up with wheels in this orientation, the flexible beams 14 & 16 will be forced apart, providing clearance so that the vehicle can be backed up around a railway vehicle. When the vehicle has backed up a sufficient distance and a railway vehicle is substantially within the beams, the arms 62 & 64 are forced up, as shown in FIG. 9. The bottom edge 110 of the beam lowers to near or at the road surface, as shown in FIG. 9. The axle 54 pivots and the wheel 56 toes out with respect to the front of the vehicle 10, as shown in FIG. 10. As the vehicle is still moving backwards, the flexible beams 14 & 16 will be forced together, moving them into contact with the railway vehicle(s) to be attached and secured for transport.

It will be understood that the vehicle 10 as described herein is intended primarily for short haul or intra-city operations, as variation in the heights of the wheels caused by driving hazards and road conditions will cause the wheels to toe in and out during driving. This has a beneficial effect of compensating for sway, a problem in high profile vehicles, at the expense of increased tire wear. The beams 14 & 16 are held parallel, however, by means for preventing the beams from spreading such as being secured to a railway vehicle 12, which then becomes a part of the structure of the vehicle. If the vehicle 10 is to be moved without a railway vehicle, other means for preventing the beams from spreading such as one or more temporary spacer bars or cables 111 should be connected between the two beams 14 & 16. The temporary spacer bars or cables may be stowed on top of the beams 14 & 16 when not in use.

Moreover, it is preferred to mount the wheels 56 as close as possible to the sides of railway vehicles being carried thereby minimizing the bending torque on the wheels and axles caused by the railway vehicles not being directly over the wheels. For this reason, the electric motors are placed on the outside of the wheels and the wheels are adapted to be changed from the inside of the beams, after any railway vehicles have been removed. This procedure can be made somewhat easier if the vehicle can be raised to a height sufficient to access retaining bolts below the lifting ledge 42. This condition is illustrated in FIG. 11. The bellows 96 can be provided with sufficient expansion to extend the wheel to the desired height. A hydraulic actuator 80 of sufficient length would be very expensive. In addition to the active cylinder 82, and the piston 86, the actuator 80 also has a passive cylinder 112, in which the active cylinder slides. As the wheel is lowered (and the vehicle raised), the actuator 80 essentially disengages, and all of the weight of the vehicle beams is borne by the air bellows 96. Since this feature is used only without a railway vehicle, and since the beams themselves are comparatively light, the bellows can raise the vehicle in this manner.

Another embodiment of the vehicle 10 is shown in FIG. 2. Vehicles with only two rear axles per beam can have an opposed or “walking beam” suspension. This variation consists of a “leading beam” or trailing beam turned around backwards so that the support axle points forward instead of to the rear. With a first set of pivot points in the rear of a “leading beam” wheel assembly and with another set of pivot points for a variable toe-in “trailing beam” wheel assembly immediately behind them, suspension actuators such as air bellows can then be horizontally mounted between right angle suspension hangers attached to the axles (as in a mountain bike suspension) to offer some structural advantages such as neutralizing the forces of the tandem rear axle to lighten the structure. However, this type of suspension fails to compensate for the problem of off-tracking due to lateral forces bending the leading beams during high speed turns. This off-tracking could become so severe in a light weight, flexible suspension that a tire might rub against a fender. A vehicle with only trailing beam suspension for rear wheel assemblies can compensate for the bending of the trailing beams by leaning the vehicle into the turn by having a computer 162 coupled to an accelerometer or other suitable sensor 164 controlling the suspension height. The computer 162 controls apparatus such as a pump 166 connected through the air line 98 to the bellows or a fluid pump coupled to the hydraulic actuator 80. Manual controls 168, such as a joystick (not shown) inside the cab are also connected to the computer 162 to control the height of the wheel assemblies. If a vehicle had a leading beam suspension with a variable toe-in feature, leaning the vehicle into the turn would increase off-tracking. Leaning a vehicle to the outside of a turn could cause cargo in the railway vehicle to fall over, so non-coplanar pivots which allow variable toe in are not recommended for “leading beam” wheel assemblies. Therefore in this embodiment, two rear wheel assemblies are provided on each of the vehicle's main structural beams 14 & 16. The wheel assemblies are in walking beam configuration with their pivots adjacent each other. The back or trailing beam wheel assembly 114 has an axis 54 and pivot points 70 & 72 that are non-coplanar, as described above in connection with the wheel assembly 24. The front or leading beam wheel assembly 116, in contrast, has co-planar pivot points 70 & 72. Only the wheel of the trailing beam wheel assembly 114 toes in or out as the vehicle is raised or lowered. This combination has the advantage of eliminating the tire scrub common to most tandem axle vehicles during sharp low speed turns by leaning the vehicle to the outside of the turn by means of a computer controlling the suspension height to steer the rear axle. An all trailing beam configuration is preferred for primarily high speed operation; and a walking beam configuration is preferred for primarily low speed operation. A tri-axle vehicle (three rear wheel assemblies on a single beam) as shown in FIG. 1, might have a combination of a pair of wheel assemblies in walking-beam configuration combined with an additional trailing beam wheel assembly. A quad-axle vehicle (four rear wheel assemblies on a single beam) might be equipped with an ordinary trailing beam (as well known in the industry) without the variable toe in feature, in addition to variable toe-in wheel assemblies as described herein.

When the vehicle 10 lifts the railway vehicle 12, the weight of the railway vehicle is primarily supported by the lip 44 on the railway vehicle carried on the lifting ledge 42 on the beams 14 & 16. To prevent the beams from flexing away from the railway vehicle, if no other attachment mechanism is provided, such as shown in U.S. Pat. No. 6,840,724 Spade Connector for Attaching an Intermodal Container to a Vehicle, other means for preventing the beams from spreading such as temporary spacer bars or cables 111 may be passed under the railway vehicle(s) and secured to each beam. The temporary spacer bars or cables 111 secure the beams against the sides of railway vehicles. Alternatively, downward projecting hooks, pins, or ridges (not shown) can be molded into the lip 44 to engage corresponding grooves, shackles, or holes molded in the lifting ledge 42 (not shown). While it is also possible to provide the lifting ledge 42 with hooks, pins, or ridges, it is preferred that the attachment mechanism be as compatible as possible with that of shipping containers so that the vehicle can have a dual use. One skilled in the art will recognize that even if a vehicle designed for off highway use is large enough to lift large railroad locomotives, as shown in FIGS. 13 and 14, it is still desirable to include additional facility to lift larger than normal shipping containers or to lift entire railcars off their bogies to place them on ships and barges or deliver their contents at ground level.

In the preferred embodiment of the vehicle 10, the beams 14 & 16 are crash absorbent, reinforced plastic, composite box structures with variable height, active hydraulic or air ride, and metal and rubber suspension components bolted to a steel sub-frame. To take full advantage of the maneuverability and collision avoidance ability a low profile vehicle allows, the variable height front wheel assembly 22 may have a fully independent, MacPherson strut design similar to automobiles and large vented disc brakes. A computer may be programmed to lean the vehicle when the steering wheel is turned all the way to the lock because leaning the vehicle has an effect of steering with the rear axles to improve turning radius. Buttons should also be provided on the steering wheel for this purpose, since steering with the rear wheels allows the vehicle to be moved diagonally when driven in confined spaces. A computer may be fitted with an accelerometer to detect high speed turns and lean the vehicle into the turns as this will counteract the natural flexibility of trailing beam suspensions and prevent off-tracking. To ease the task of keeping such an over-wide vehicle in its lane, the driving position should be centrally located. Rear view video cameras should be installed instead of mirrors to reduce the need for the driver to turn his head to see what is behind the vehicle. Steel skid plates may be installed on the bottom of the vehicle. The front bumper and sides of the vehicle should be two inches higher off the ground than the skid plates and the same height as car bumpers when at normal ride height. Additional skid plates should be installed in the back of the cab where the cab slides on railroad tracks when lifting rail vehicles.

The vehicle should be provided with a joystick or other suitable control means for controlling the height of the vehicle. The joystick should be equipped with a trigger button on the front which will disable the joystick when the button is released so as not to operate the vehicle if the device is accidentally jostled or bumped. The joystick should operate only when the trigger button is pushed. The computer should be programmed so that when the joystick is pushed forward when the trigger button is squeezed, the vehicle will lower to the ground. Similarly, pulling back on the device will raise the vehicle. Moving the joystick from side to side will alter the vehicle's lean and rear steering. The joystick should be equipped with additional control means such as a “hat” type switch similar to computer videogame joysticks which will control the pitch of the vehicle, lowering the front while raising the rear when the hat switch is pushed forward and raising the front and lowering the rear of the vehicle when the hat switch is moved back. Moving the hat switch left and right should select camera views if the vehicle is equipped with more than one camera under the cab (not shown) for observing the position of rail vehicle wheels with respect to the track. When the hat switch is in a neutral position, the video monitors should show the views through the vehicle's normal rear view cameras as used when traveling on the highway. The joystick should also be equipped with a button to allow the device to be used to control the height of the front suspension independently from the rear suspension and a similar button to control the rear suspension separately from the front. A third button should restore normal function.

The preferred method for placing railcars on the tracks is illustrated in FIG. 12. It will be understood that certain conventional features such as brakes and mounting bolts are not shown and many vehicle components described above have been omitted for clarity. The vehicle 10 is shown in position above a railroad track 11 in preparation for placing a rail vehicle 12 on the rails 13 & 15. The left rear wheel 17 of the rail vehicle 12 is shown in contact with the left rail 13. It will be understood that the rail vehicle's wheels are mounted on a conventional articulated rail truck or bogie 25 which is pivotally attached to the rail vehicle 12 by means of upper and lower couplers 27 & 29 well known in the art to be capable of allowing pivotal movement around axis B, which is located equidistantly between the four rail wheels 17, 19, 21, & 23. The vehicle 10 mounts the rail vehicle 12 on the track 11 by moving diagonally forward and to the left while simultaneously lowering the rail vehicle 12 and bogie 25 downward toward the track. Because the wheel 17 remains continuously in contact with the rail 13 during this procedure, this movement of the vehicle has the effect of pivoting the bogie 25 around axis B until the wheel 19 is also brought into contact with the rail 13. Once the left wheels 17 & 19 are positioned on the left rail 13, the vehicle is leveled to bring the right wheels 21 & 23 into contact with the right rail 15. Those knowledgeable in the art will recognize that bogies having three or more axles can be brought into alignment in a similar manner.

It will be understood that while the vehicle 10 is shown leaning to the left, the rail vehicle 12 can alternately be placed on the tracks by leaning the vehicle 10 to the right and first placing the right front wheel 23 on the right rail 15 instead of first placing the left rear wheel 17 on the left rail 13 as shown. Similarly, if the bogie 25 was misaligned in the opposite direction and the left front wheel 19 were lower to the track than the left rear wheel 17 when the vehicle is leaning to the left, the same procedure could alternately begin by placing the left front wheel 19 on the left rail 13 first or the right rear wheel 21 could be placed on the right rail 15 first if it were lower than the right front wheel 23 when the vehicle was leaning to the right. Regardless which wheel is placed on the track first, the other wheel(s) on the same side of the bogie will be positioned on the same rail as the first wheel by simultaneously lowering the vehicle and moving it toward the same rail upon which the first wheel is placed. This causes the bogie to pivot around axis B until all of the bogie's wheels are in alignment with the rails. Similarly, if the rail vehicle 12 has more than one bogie (not shown), or if more than one rail vehicle is to be placed on the track at the same time, all of the bogies can be brought into alignment simultaneously by steering with the vehicle's steering wheel and by moving a hat switch, buttons, or similar controls to operate the front or rear suspension height differentially or independently to control the distance between the bogies and the rail. It will be understood that the operator can see the bogies through a video camera (not shown) mounted under the cab 18 to determine what steering and height corrections are necessary to achieve simultaneous alignment of the wheels on multiple bogies with the track. Alternatively, the vehicle can be provided with sensors such as radar or machine vision to determine the bogies' distance from the rails so as to make the steering and height corrections automatically with a computer. Regardless whether operated manually by controls or automatically by sensors, once the wheels on one side of a rail vehicle are placed on the track, the suspension is moved to a neutral position to level the rail vehicle, which those knowledgeable in the art will recognize will result in the remaining wheels being placed on the other rail.

It is preferred that the vehicle be moving in the forward direction away from parked rail vehicles while placing rail vehicles on tracks so as to avoid collisions or unintended coupling with other rail vehicles because tilting rail vehicles will cause their couplers (not shown) to become misaligned with respect to the couplers of other trains. Those knowledgeable in art will recognize that contact between misaligned couplers could result in damage to one or both couplers. When placing rail vehicles on the tracks to be coupled to a train, all of the wheels should first be placed on the tracks. Then it is preferred that the vehicles' brakes (not shown) be released by connecting an air hose 31 provided in the back of the vehicle with a similar air hose 33 connected to the rail vehicles' braking systems, which those knowledgeable in the art will recognize, usually results in the rail vehicles' brakes being released when working fluid such as compressed air is supplied. Alternatively, rail vehicles can be equipped with modular couplers of a type shown in U.S. Pat. No. 6,776,299 which incorporates pneumatic and electrical connections between rail vehicles in one modular unit. Vehicles for carrying rail vehicles so equipped, such as those having a brake by wire system, should also be equipped with a similar modular coupler in the back of the cab 18 so that the rail vehicles' brakes can be released by means of a remote control without the need for the operator to exit the vehicle. Alternatively, if rail vehicles are equipped with radar collision avoidance systems, such as on a magnetically levitated train, the vehicle can be equipped with a microwave transponder or other means of wireless communication, such as a radio or infrared port well known to those knowledgeable in the electrical arts to be capable of releasing rail vehicle brakes by remote control. Once the rail vehicles' brakes are released, they can then be backed down the track to safely couple with other trains.

The vehicle's computer should be programmed to display a schematic and cursor so that each wheel is capable of being selected independently by pressing additional buttons. When a suspension component is selected, the joystick should affect only the component(s) selected. In this way a wheel can be lifted up if it has a flat tire or other or other malfunction-allowing the vehicle to travel to a repair facility. The computer should also be capable of disabling certain commands, such as the command to rise to above normal ride height when loading or unloading rail vehicles under a bridge or inside a building with limited clearance or aboard a ship with limited headroom between decks.

One skilled in the art will recognize that other methods for providing controls may be selected without departing from the teachings of this invention.

Although I have now described my invention in connection with my preferred embodiment, those skilled in the art will recognize that my invention may take other forms without departing from the spirit or teachings thereof. The foregoing description is intended, therefore, to be illustrative and not restrictive, and the scope of my invention is to be defined by the following claims:

What is claimed is:

1. A vehicle for lifting and transporting railway vehicles, the vehicle comprising
a substantially U-shaped frame, said frame having first and second substantially parallel beams, said beams being spaced apart to receive a railway vehicle there between, and being deflectable towards and away from each other,
at least one wheel pivotally mounted on said first beam, said wheel pivoting to deflect said first beam away from or toward said second beam as said vehicle is moved forward or backward.

2. The vehicle of claim 1 wherein said beams are flexible and bow outwardly or inwardly in response to the pivot of said wheel.

3. The vehicle of claim 1 further comprising a cab, said cab further comprising operator controls and steerable wheels, said beams being connected to said cab.

4. The vehicle of claim 3 wherein said beams are flexible and bow outwardly or inwardly in response to the pivot of said wheel mounted on said beam.

5. The vehicle of claim 1 wherein said first beam further comprises an inner wall and an outer wall and said pivotally mounted wheel is mounted between said inner and outer walls on
a wheel axle, said wheel axle being supported by
an inner arm and an outer arm,
said inner arm being connected to a first pivot, said first pivot being connected to said first beam adjacent said inner wall of said first beam,
said outer arm being connected to a second pivot, said second pivot being connected to said first beam adjacent said outer wall of said first beam, said axle, said first pivot and said second pivot being non-coplanar.

6. The vehicle of claim 5 wherein said second pivot is higher than said first pivot.

7. The vehicle of claim 6 wherein a line between said first and second pivots is elevated from horizontal by an angle of between 0.5 and 10 degrees.

8. The vehicle of claim 7 wherein said angle is between 1 and 6 degrees.

9. The vehicle of claim 8 wherein said angle is between about 2 and 3 degrees.

10. The vehicle of claim 6 wherein said first and second pivots are connected by a support axle.

11. The vehicle of claim 10 wherein said first arm and said second arm are rigidly connected to said support axle and said support axle is pivotally connected to said first beam and further comprising an hydraulic cylinder coupled between at least one of said first and second arms and said beam, said hydraulic cylinder raising and lowering said beam with respect said wheel and simultaneously causing said wheel to pivot with respect to said beam.

12. The vehicle of claim 11 wherein said wheel pivots as the beam is raised above a neutral position such that the beam is forced outwardly when the vehicle is driven backward towards an open end of said U-shaped frame and wherein said wheel pivots as the beam is lowered below said neutral position such that the beam is forced inwardly when the vehicle is driven backward.

13. The vehicle of claim 11 wherein said support axle comprises an inner cylinder connected between said inner and said outer walls of said beam, said cylinder having an air flow passage opening through said walls, and
a sleeve rotatably mounted around said inner cylinder, said arms being rigidly connected to said sleeve.

14. The vehicle of claim 5 wherein said vehicle further comprises at least one motor coupled to said wheel axle of said at least one wheel.

15. The vehicle of claim 1 further comprising at least one second beam wheel pivotally mounted on said second beam, said second beam wheel pivoting to deflect said second beam away from or toward said first beam as said vehicle is moved forward or backward.

16. The vehicle of claim 15 wherein said beams each further comprise an inner wall and an outer wall and said pivotally mounted wheels are each mounted between said inner and outer walls on a wheel axle, each of said wheel axles being supported by
an inner arm and an outer arm,
each of said inner arms being connected to a first pivot, said first pivot being connected to the respective beam adjacent said inner wall of said respective beam,
each of said outer arms being connected to a second pivot, said second pivot being connected to a respective beam adjacent said outer wall of said respective beam,
said axle, said first pivot and said second pivot being non-coplanar and said second pivots being higher than said first pivots.

17. The vehicle of claim 16 wherein said first and second pivots are connected by a support axle and said first arms and said second arms are rigidly connected to said support axle and each of said support axles are pivotally connected to a beam and further comprising an hydraulic cylinder coupled between at least one of said first and second arms and said beam, said hydraulic cylinder raising and lowering said beam with respect said wheel and simultaneously causing said wheel to pivot with respect to said beam, said wheels pivoting as the beams are raised above a neutral position such that the beams are forced outwardly when the vehicle is driven backward towards an open end of said U-shaped frame and said wheels pivoting as the beams are lowered below said neutral position such that the beams are forced inwardly when the vehicle is driven backward.

18. The vehicle of claim 15 further comprising a cab, said cab comprising operator controls and having steerable wheels, said beams being connected to said cab, said beams being deflectable outwardly or inwardly in response to the pivot of said wheels mounted on said beams.

19. The vehicle of claim 1 wherein each beam further comprises a ledge along said inner wall of said beam for supporting railway vehicles between said beams.

20. The vehicle of claim 1 wherein each beam further comprises means for preventing said beams from spreading apart from each other.

21. The vehicle of claim 20 wherein said means for preventing the beams from spreading comprise means for connecting to a railway vehicle positioned between the first and second beams.

22. The vehicle of claim 21 wherein said beams each further comprise an inner wall and an outer wall and said pivotally mounted wheels are each mounted between said inner and outer walls on a wheel axle, each of said wheel axles being supported by
an inner arm and an outer arm,
each of said inner arms being connected to a first end of a support axle,
each of said outer arms being connected to a second end of said support axle, said wheel axle, said support axle pivot being non-coplanar and said second end of said support axle being higher than said first end of said support axle and said first arms and said second arms are rigidly connected to said respective support axles and each of said support axles is pivotally connected to a beam and at least one means for preventing the beams from spreading is mounted on said beam near a support axle.

23. The vehicle of claim 1 further comprising means for pivoting said wheel, control means for automatically controlling said pivoting means and a sensor coupled to said control means, said sensor producing a signal representative of motion of said vehicle, said control means responsive to said sensor.

24. The vehicle of claim 15 further comprising means for pivoting said wheels to deflect said beams together in a diagonal direction as said vehicle is moved forward or backward, control means for automatically controlling said pivoting means and a sensor coupled to said control means, said sensor producing a signal representative of motion of said vehicle, said control means responsive to said sensor.

25. The vehicle of claim 18 further comprising means for pivoting and steering said wheels to deflect said vehicle in a diagonal direction without turning said vehicle as said vehicle is moved forward or backward, control means for automatically controlling said steering and pivoting means and a sensor coupled to said control means, said sensor producing a signal representative of motion of said vehicle, said control means responsive to said sensor.
